(19) United States
(12) Patent Application Publication
(10) Pub. No.: US 2022/0355358 A1
(43) Pub. Date: Nov. 10, 2022

(54) METHOD FOR PRODUCING A SHEET METAL PART

(71) Applicant: Mahle International GmbH, Stuttgart (DE)

(72) Inventors: Thorsten Grelle, Stuttgart (DE); Leonard Lorenz, Stuttgart (DE); Michael Rehermann, Stuttgart (DE); Peter Wieske, Korntal-Muenchingen (DE)

(21) Appl. No.: 17/737,013

(22) Filed: May 4, 2022

(30) Foreign Application Priority Data
May 5, 2021 (DE) 102021204524.3

(51) Int. Cl. B21D 21/00; B21D 28/22; B21D 5/00

(52) U.S. Cl. CPC B21D 21/00; B21D 28/22; B21D 5/00

(57) ABSTRACT

A method for producing a sheet metal part for a laminated core of a rotor of an electric motor, a sheet metal part, and a rotor are disclosed. The method includes punching out the sheet metal part from a sheet metal strip to provide at least two recesses and at least two rotor webs; and forming an elevation at least in one region that protrudes out of the sheet metal part with respect to a sheet metal part plane.

### CROSS-REFERENCE TO RELATED APPLICATION

This application claims priority to German Application No. DE 10 2021 204 524.3 filed on May 5, 2021, the contents of which are hereby incorporated by reference in its entirety.

### TECHNICAL FIELD

The present invention relates to a method for producing a sheet metal part for a laminated core of a rotor of an electric motor. In addition, the invention relates to a sheet metal part produced according to this method and to a rotor of an electric motor having multiple such sheet metal parts stacked onto one another and connected to one another.

### BACKGROUND

From DE 10 2018 107 916 A1 a generic method for producing a sheet metal part for a laminated core of a rotor of an electric motor having at least two recesses and at least two rotor webs is known, according to which the sheet metal part is punched out of a sheet metal strip. In the process, the sheet metal part to be punched out is positioned between a punch and an associated die of a punching tool, wherein following this a relative movement between the punch and the die takes place in such a manner that the punching-out of the sheet metal part is carried out and after completion of the relative movement between the punch and the die required for the punching-out a cold forming of the sheet metal part takes place in selected regions of the sheet metal part for the purpose of reducing the magnetic permeability in that in the selected regions a force acts on the sheet metal part held between the punch and the die and during the further course a renewed relative movement between the punch and the die takes place for the purpose of removing the punched-out sheet metal part from the punching tool.

Producing sheet metal parts by means of a punching process and also the local compressing of such sheet metal parts for example in order to increase the mechanical strength or reduce the magnetic conductivity has already been known for a long time. In the process, the individual sheet metal parts are punched out of a sheet metal strip and for example at an edge of recesses through which wires or magnets can be passed later on, additionally densified. The webs that are created circumferentially or between two recesses should be as thin as possible in order to minimise a stray magnetic field but because of strength requirements must not fall below a certain thickness.

The present invention therefore deals with the problem of stating an improved or at least an alternative embodiment for a method of the generic type, with which in particular sheet metal parts with higher strength can be produced.

According to the invention, this problem is solved through the subjects of the independent claim(s). Advantageous embodiments are subject of the dependent claims.

### SUMMARY

The present invention is based on the general idea of no longer forming sheet metal parts which, to date, are assembled into a laminated core for a rotor of an electric motor so as to be flat, but to form at least one region out of their plane, in particular in the region of rotor webs, as a result of which both the strength of the sheet metal parts can be increased and also stray magnetic fields occurring for example in the region of these rotor webs reduced. With the method according to the invention for producing a sheet metal part for a laminated core of a rotor of an electric motor having at least two recesses and at least two rotor webs, the sheet metal part is punched out of a flat sheet metal strip. During or after the punching-out, the sheet metal part is formed at least in one region so that an elevation protruding out of a sheet metal part plane is created, so that the sheet metal part merely formed in the manner of a flat in the past is now given a three-dimensional shape. Thus, the invention utilises the principle of three-dimensional forming. By way of this three-dimensional shape the strength can be increased as a result of which in particular higher rotational speeds and a higher output of an electric motor equipped with such a rotor also become possible. Here, the elevation can be formed as a positive elevation or as a negative elevation, wherein in the latter case the negative elevation projects on the opposite sheet metal part side.

In an advantageous further development of the method according to the invention, the at least two rotor webs are formed so as to form links to the elevation protruding obliquely out of the sheet metal part plane. In the process, the rotor webs are lengthened and plasticised without the outer diameter of the sheet metal part changing. Through the plasticisation the strength of the rotor webs increases by way of which the rotational speed stability is raised. Apart from this, the magnetic permeability in the region of the rotor webs is reduced and thus the stray field diminished, resulting in an increase of the torque.

In a further advantageous embodiment of the method according to the invention, the formed elevation is connected to the sheet metal part plane via three rotor webs, wherein the elevation forms a parallel plane to the sheet metal part plane. By way of this it is possible for example via the three rotor webs to arrange individual flat areas spaced apart parallel to the actual component plane, as a result of which a comparatively simple forming is made possible. Through the parallel planes of the elevation and of the sheet metal part plane, a flat joining of multiple sheet metal parts to form a laminated core of a rotor of an electric motor can also take place.

In a further advantageous embodiment of the method according to the invention, one of the three rotor webs extends to the elevation formed by the parallel plane in the radial direction of the sheet metal part while two rotor webs are arranged on an outer circumferential region. By way of this, a limitation for example of the recesses radially to the outside can take place wherein the centrifugal forces acting on the parallel plane are absorbed by the rotor webs extending in the radial direction.

In a further advantageous embodiment of the method according to the invention, the at least one formed region is formed in the manner of an at least partial annular channel or bead. Such a channel or such a bead can comprise for example a rounded, a triangular or a trapezoidal cross-section. An elevation or channel formed in such a manner can also increase the component strength and stiffness of the sheet metal part as a result of which higher rotational speeds of an electric motor equipped with such sheet metal parts are made possible. In addition, a higher reluctance torque can also be achieved. The higher reluctance torque is the portion of the torque created by the magnetic attraction of the iron of the core. The rotor webs reduce this portion of the torque. The smaller the rotor webs are the more reluctance torque can be achieved. The method is therefore also highly suitable for synchronous reluctance machines which do not have any magnets or coils in the rotor but merely utilise the reluctance torque created through the rotor made of iron.

In a further advantageous embodiment of the method according to the invention, the sheet metal part is compressed, in particular in the radial direction, during or after the forming. By way of the compression, residual compressive stresses can also be introduced which in turn make possible an increased rotational speed since these residual compressive stresses first have to be removed in order to introduce tensile stresses into the component.

Further, the present invention is based on the general idea of using a sheet metal part produced according to the method described in the preceding paragraphs with a rotor of an electric motor, wherein multiple such sheet metal parts are stacked onto one another and connected to one another. By way of this, the advantages previously described with respect to the individual sheet metal parts can be accumulated, so that a rotor of an electric motor produced with such sheet metal parts does not only have an increased strength because of for example applied residual compressive stresses, but is also able for example to accommodate same-size magnets with reduced use of material, as a result of which a higher torque with same use of magnet material can be achieved.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1 and extract of a sheet metal part according to the invention for a laminated core of a rotor of an electric motor in a first embodiment,

FIG. 2 an extract of a laminated core for a rotor of an electric motor produced from multiple sheet metal parts according to the invention,

FIG. 3 different view of a further possible embodiment of the sheet metal part according to the invention,

FIG. 4 to FIG. 6 representations each analogous to FIG. 3, however each with different embodiment.

### DETAILED DESCRIPTION

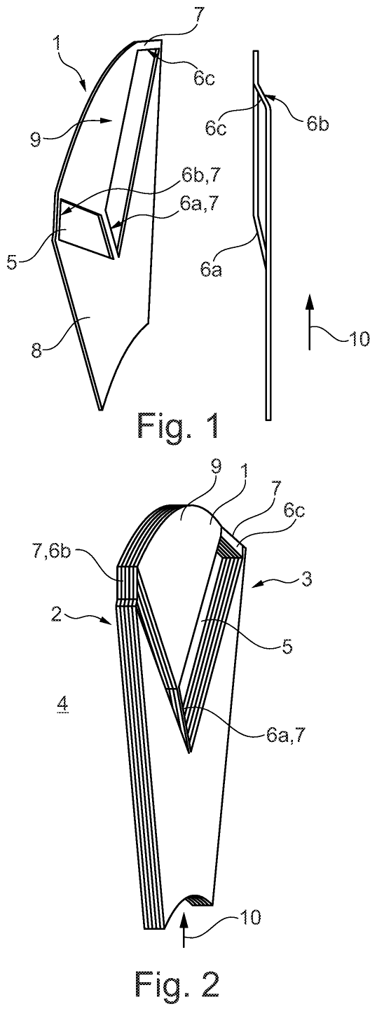

According to FIGS. 1 to 6, a sheet metal part 1 according to the invention for a laminated core 2 (see FIG. 2) of a rotor 3 of an electric motor 4 comprises at least two recesses 5 for magnets and at least two rotor webs 6a, 6b and 6c. The sheet metal part 1 according to the invention is initially punched out of a flat sheet metal strip and during the punching or thereafter formed in at least one region 7 so that an elevation 9 protruding out of a sheet metal part plane 8 is created. As described here, this elevation 9 can have many different embodiments and can also be negative.

Viewing for example the embodiment of the sheet metal part 1 according to FIGS. 1 and 2, the rotor webs 6a, 6b and 6c there are formed so that these form links to the elevation 9 protruding obliquely out of the sheet metal plane 8. In this case, the elevation 9 lies on a plane that is spaced apart parallel to the sheet metal part plane 8.

Through the rotor webs 6a, 6b and 6c obliquely protruding from the sheet metal part plane 8 and the elevation 9, a strengthening of the entire sheet metal part 1 can be achieved as a result of which higher rotational speeds are possible. At the same time, the obliquely oriented rotor webs 6a, 6b, 6c also influence the magnetic properties in that these are lengthened and plasticised without the outer diameter of the sheet metal part 1 changing. Through the plasticisation, the strength of the rotor webs 6a, 6b, 6c increases, causing the rotational speed stability to be raised. Apart from this, the magnetic permeability in the region of the rotor webs 6a, 6b, 6c is reduced and the stray field thus diminished which leads to an increase of the torque.

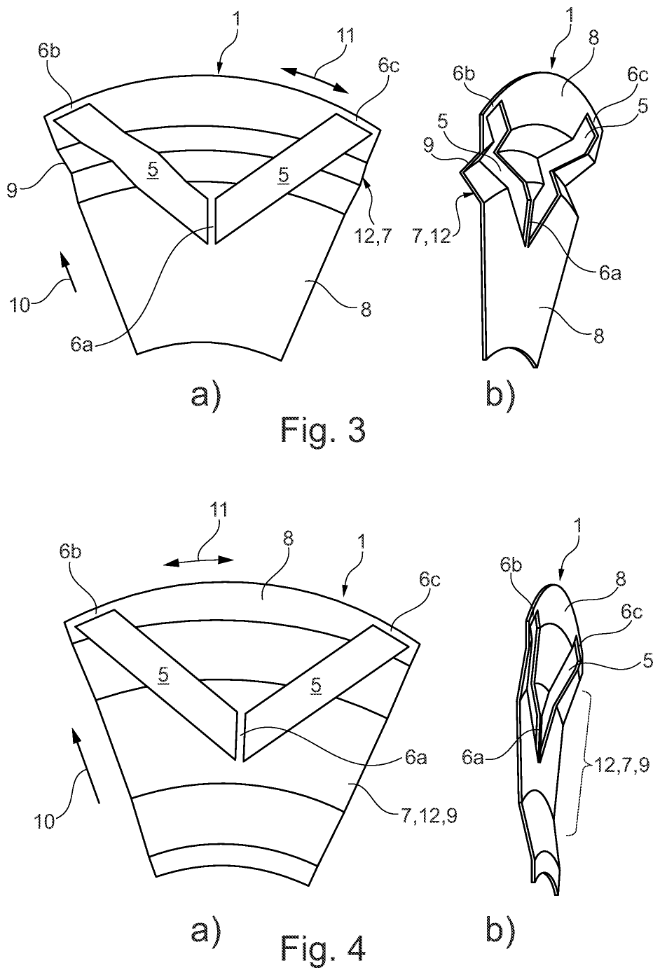

Viewing FIGS. 1 and 2, but also FIGS. 3 to 6 further it is noticeable that a rotor web 6a extends in the radial direction 10 of the sheet metal part 1 while the two rotor webs 6b and 6c are arranged on an outer circumferential region and accordingly extend in the circumferential direction 11. Here, the rotor webs 6a, 6b and 6a and 6c respectively as well as the sheet metal part 1 in the component plane 8 and the sheet metal part 1 in the elevation 9 delimit the recesses 5 in which for example magnets or wires of coils are arranged.

The sheet metal part 1 according to FIGS. 3a and 3b comprises rotor webs 6a, 6b and 6c lying in the component plane 8, wherein the at least one formed region 7 is formed in the manner of an at least partial annular channel 12 with triangular cross-section. Viewed from the other side, this channel 12 is a bead. By way of this, a bead-like stiffening of the sheet metal part 1 can take place as a result of which the same likewise gains stiffness. The channel 12 increases the stiffness of the rotor 3. The channel 12 or generally a bead is present in order to introduce compressive stresses into the rotor webs 6a, 6b, 6c which then increase the rotational speed stability.

Viewing the sheet metal part 1 shown according to FIG. 4, the same likewise comprises a channel 12 as formed region 7 (negative elevation 9), wherein however the radial extent of this channel 12 is significantly greater than the radial extent of the channel 12 according to FIG. 3, 5 or 6. Here, the recesses 5 also run obliquely to the radial direction 10.

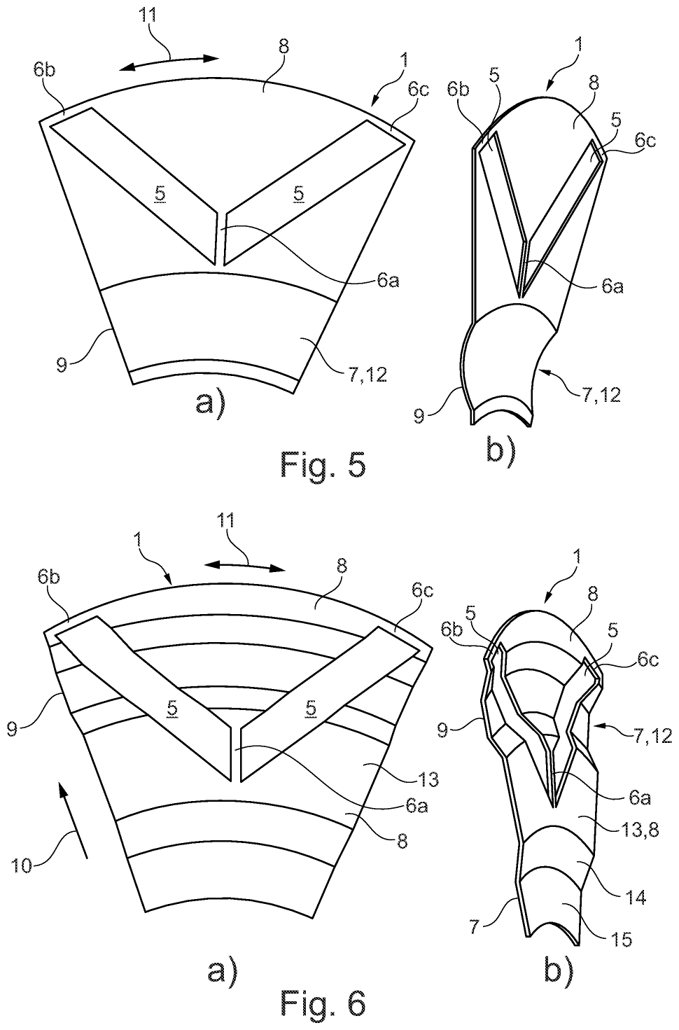

In the sheet metal parts according to FIGS. 5a and 5b, a formed region 7 in the manner of a partial annular channel 12 is likewise noticeable which lies radially within the recesses and does not run, like the regions 7 in the sheet metal parts 1 according to FIGS. 3 and 4, through the recesses 5. In addition, the channel 12 according to FIGS. 5a and 5b has a rounded cross-section or channel base.

On the sheet metal part 1 according to FIGS. 6a and 6b, two formed regions 7 are noticeable which are arranged spaced apart from one another in the radial direction, wherein the radially outer region 7 likewise comprises a channel 12, however with a trapezoidal cross-section. This channel 12 in turn likewise runs through the recesses 5. However, the recesses 5 extend also in a middle region 13 which lies at the height of the component plane 8. Radially within the middle region 13, a formed region 7 is again noticeable. The same merges from the middle region 13, via a slope 14, into the radial inner region 15.

Besides the forming substantially orthogonally to the component plane 8 for producing the elevations 9 which, viewed conversely, can obviously also represent depressions, an compression of the sheet metal part 1 during or after the forming, in particular against the radial direction 10 can also take place, wherein residual compressive stresses are applied to the sheet metal part 1 which in turn increase the component strength. Upon a rotation of the rotor 3 the residual compressive stresses applied against the radial direction 10 have to be compensated for by centrifugal forces in order to exert tensile forces on the sheet metal part 1 thereafter.

The sheet metal part 1 can be comparatively easily produced by punching and forming, wherein the advantages that can be achieved by forming the region 7 and producing an elevation 9 are astonishing. These advantages lie in particular in an increased strength and stiffness as well as in a reduction of the magnetic permeability in the region of the rotor webs 6a, 6b, 6c. By increasing the strength, a higher rotor rotational speed with same web size can be achieved or a smaller web size used with the same rotational speed and thus the torque increased or the use of magnet material reduced.

With such a sheet metal part 1, which in FIGS. 1 to 6 is merely shown circular segment-like but which is usually formed disc-shaped and circular in shape, the advantages described for the individual sheet metal part 1 can also be applied to a rotor 2 equipped with such sheet metal parts 1 and to an electric motor 3 equipped with such a rotor 2.

1. A method for producing a sheet metal part for a laminated core of a rotor of an electric motor, comprising:
punching a sheet metal strip to provide at least two recesses and at least two rotor webs, and
forming an elevation at least in one region protruding out with respect to a sheet metal part plane.

2. The method according to claim 1, wherein punching the sheet metal strip including forming the at least two rotor webs to provide linkages to the elevation obliquely protruding out of the sheet metal part plane.

3. The method according to claim 2, wherein punching the sheet metal strip provides at least three rotor webs, and the elevation is connected to the sheet metal part plane via the at least three rotor webs, and wherein the elevation forms a parallel plane to the sheet metal part plane.

4. The method according to claim 3, wherein at least one of the at least three rotor webs extends in a radial direction of the sheet metal part, and at least two other of the at least three rotor webs are arranged on an outer circumferential region.

5. The method according to claim 1, wherein the at least one region is formed as an at least partial annular channel.

6. The method according to claim 5, wherein the at least partial annular channel is rounded, triangular or trapezoidal in a cross-section.

7. The method according to claim 5, wherein the at least one region includes two partial annular channels with different radii.

8. The method according to claim 1, further comprising compressing the sheet metal part during or after the forming.

9. A sheet metal part, comprising:
at least two recesses and at least two rotor webs; and
an elevation disposed in at least one region protruding out with respect to a sheet metal part plane.

10. A rotor of an electric motor, comprising:
a plurality of sheet metal parts stacked onto one another and connected to one another, wherein the plurality of sheet metal parts include:
at least two recesses and at least two rotor webs; and
an elevation disposed in at least one region protruding out with respect to a sheet metal part plane;
magnets or wires arranged in the at least two recesses of the plurality of sheet metal parts.

11. The rotor according to claim 10, wherein the at least two rotor webs of at least one of the plurality of sheet metal parts provide linkages to the elevation, and wherein the at least two rotor webs obliquely protrude from the sheet metal part plane.

12. The rotor according to claim 10, wherein the at least two rotor webs of at least one of the plurality of sheet metal parts include three rotor webs, and wherein the elevation forms a parallel plane to the sheet metal part plane.

13. The rotor according to claim 12, wherein one of the three rotor webs extends in a radial direction of the at least one sheet metal part, and two other of three rotor webs are arranged on an outer circumferential region.

14. The rotor according to claim 10, wherein the at least one region is structured as an annular channel.

15. The rotor according to claim 14, wherein the annular channel has a cross-section that is rounded, triangular, or trapezoidal.

16. The sheet metal part according to claim 9, wherein the at least two rotor webs provide linkages to the elevation, and wherein the at least two rotor webs obliquely protrude from the sheet metal part plane.

17. The sheet metal part according to claim 9, wherein the at least two rotor webs include three rotor webs, and wherein the elevation forms a parallel plane to the sheet metal part plane.

18. The sheet metal part according to claim 17, wherein one of the three rotor webs extends in a radial direction, and two other of three rotor webs are arranged on an outer circumferential region.

19. The sheet metal part according to claim 9, wherein the at least one region is structured as an annular channel.

20. The sheet metal part according to claim 19, wherein the annular channel has a cross-section that is rounded, triangular, or trapezoidal.
